(19) United States
(12) Patent Application Publication
(10) Pub. No.: US 2008/0040143 A1
(43) Pub. Date: Feb. 14, 2008

(54) TRACKING SYSTEM AND METHOD

(76) Inventors: Mark Douglas Freeman, Richmond, VA (US); William Buono, Charlottesville, VA (US)

Correspondence Address: BAKER & MCKENZIE LLP, 1114 AVENUE OF THE AMERICAS, NEW YORK, NY, 10036, US

(21) Appl. No.: 11/843,281

(22) Filed: Aug. 22, 2007

Related U.S. Application Data
(63) Continuation of application No. 10/024,799, filed on Dec. 19, 2001, now abandoned.

(51) Int. Cl. G06Q 30/00

(52) U.S. Cl. 705/1

(57) ABSTRACT

System and method for tracking user activity. A user accessing a first web page is identified and an impression associated with the first web page that is selected by the user is determined. The impression is assigned a unique identification and is one of a plurality of impressions for directing the user to a second web page. The unique identification of the selected impression is transmitted to a website associated with the second web page upon the user selecting the impression and data is received from the website indicating that the user successfully performed at least one predetermined task and the unique identification. The received data is stored in a memory unit.

### TECHNICAL FIELD OF THE INVENTION

The present application relates to tracking user's activities and, more particularly, to a system and method for tracking which impression or advertisement link was selected by a user and led to the user successfully performing at least one predetermined task.

### BACKGROUND OF THE INVENTION

An impression refers to on-line advertising displayed as views on World Wide Web (“web”) pages. Typically, on-line publishers offer and their customers buy advertising measured in terms of ad views or impressions. A single web page may contain multiple impressions, i.e., multiple views that advertise products and services. Impressions are typically logged in a log that is maintained by the site server. Programs like Web Trends read the log, abstract meaning from it, and generate a report about site usage. Other programs, such as Central Ad, can keep track of all ad impressions that have been sent and how many of these were clicked on by users.

Although these programs may keep track of certain data about the impression, they do not attempt to track who and which impression actually led to the user buying the product or service advertised on the impression. Accordingly, a need exists for capturing extensive on-line behavior information, such as tracking an impression-driven visitor through a web site to other web sites. Such information will provide important factors in determining how a successful on-line advertising should be launched or published.

Also, there is a need for collecting information in real-time on the final disposition of visitors referred to other web sites. Such information may be used to quantify the effect the changes to a web site have on the sale of co-branded products and services. Further, companies can understand the relationship between the content selected on a web site and the result generated during the fulfillment process, e.g., whether someone made a purchase.

### SUMMARY OF THE INVENTION

The present invention is directed to tracking impressions on the World Wide Web (“web”) pages and determining whether an impression led a user to purchasing a product advertised in the contents of the impression. In one aspect, when a user clicks on the impression, an impression identifier is appended to the Uniform Resource Locator (“URL”) in the HTTP transactions. The destination web site that receives the HTTP transaction then processes the user's request and if the user purchases an item or service from that web site, that web site returns to the site that displayed the impression, the impression identifier along with a data packet indicating, inter alia, that a fulfillment or a purchase was made.

In another aspect, an impression or an advertisement link that was selected from an e-mail message may also be tracked by transmitting to a web site associated with the impression or the advertisement link, user identification, and the impression identification.

In another aspect, an impression or an advertisement link may be selected from any other user interface that is enabled to include an impression or an advertisement link.

Further features and advantages of the present invention as well as the structure and operation of various embodiments of the present invention are described in detail below with reference to the accompanying drawings. In the drawings, like reference numbers indicate identical or functionally similar elements.

### BRIEF DESCRIPTION OF THE DRAWINGS

Preferred embodiments of the present invention will now be described, by way of example only, with reference to the accompanying drawings in which:

FIG. 1 illustrates an example of a tracking system in one embodiment;

FIG. 2 illustrates an example of data stored in the memory unit shown in FIG. 1;

FIG. 3a illustrates an example of data fields in the impression table shown in FIG. 2;

FIG. 3b illustrates an example of data fields in the tracking table shown in FIG. 2;

FIG. 3c illustrates an example of data fields in the page view table shown in FIG. 2;

FIG. 3d illustrates an example of data fields in the purchase table shown in FIG. 2;

FIG. 4 illustrates an example of web pages in one embodiment; and

FIG. 5 is an example of a flow diagram that illustrates tracking impression selected by a user that leads to at least one subsequent task being performed by the user.

### DETAILED DESCRIPTION OF THE INVENTION

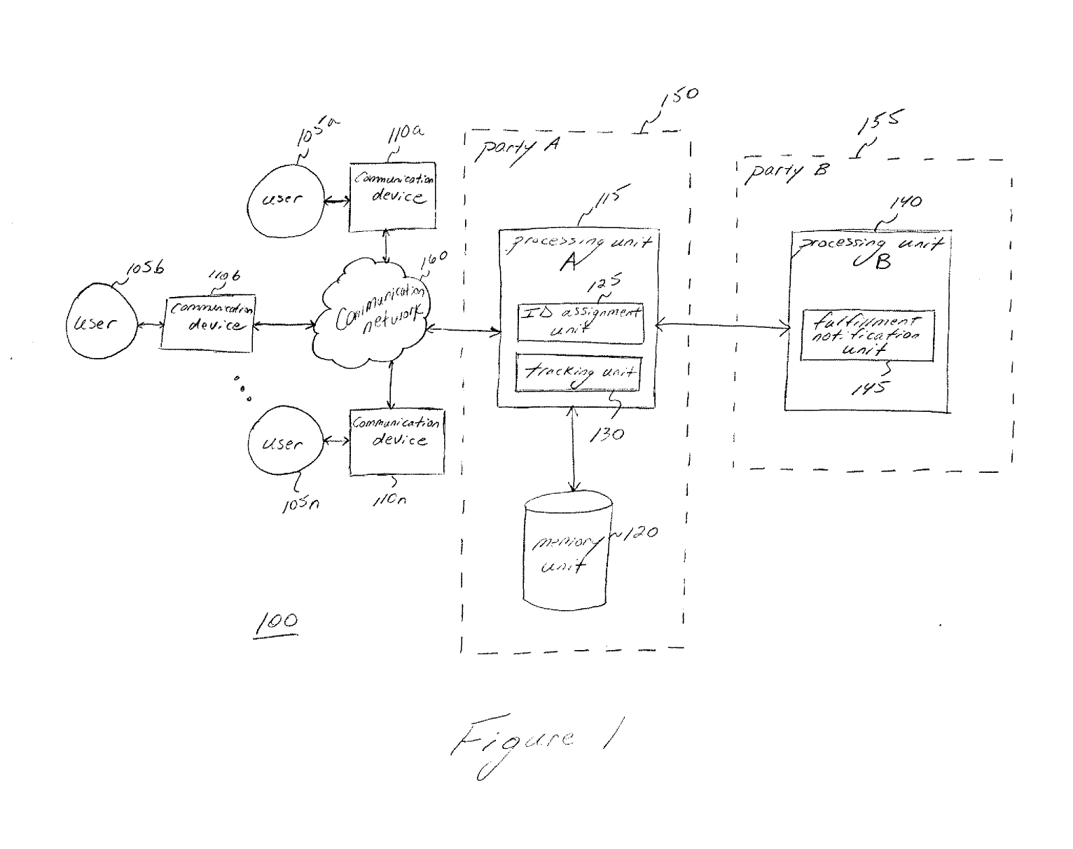

FIG. 1 illustrates an exemplary tracking system 100 of the present application. Tracking system 100 includes a plurality of users 105a . . . 105n operating respective communication devices 110a . . . 110n. In an exemplary embodiment, communication devices 110a . . . 110n are personal computers, such as laptops or desktops, which communicate with one or more other devices via communication network 160, for example, via the Internet. Even though communication network 160 is referred to hereafter as the Internet, communication network 160 of the present application is not meant to be limited to the Internet. Any known communication network can be incorporated into tracking system 100. Alternatively, one or more of communication devices 110a . . . 110n can be cellular telephones or personal digital assistants that allow Internet access. Any communication device that enables a user to select a banner or link associated with a web site and displayed on the respective communication device can be used in tracking system 100. The banner or link, e.g., are advertisements displayed on a web page, which when clicked on, directs users to a different URL, e.g., to the web site of a vendor or party advertising the products or services on the banner or link.

Tracking system 100 also includes processing unit A 115 and memory unit 120 coupled thereto, processing unit A 115 including identification (“ID”) assignment unit 125 and tracking unit 130. Processing unit A 115 and memory unit 120 are associated with party A 150 and are coupled to communication devices 110a . . . 110n through communication network 160, the Internet. In an exemplary embodiment, processing unit A 115 of party A 150 hosts one or more web pages including one or more links and/or banners, referred to herein also as impressions, which can be viewed on communication devices 110a . . . 110n. Impressions discussed in the present application can also include links and banners contained or attached to e-mails sent to users 105a . . . 105n.

Further, tracking system 100 includes processing unit B 140 associated with party B 155. Processing unit B 140 includes fulfillment notification unit 145 and is coupled to processing unit A 115. In the exemplary embodiments of the present application, party B 155 is different from party A 150, such as a different company. When a user, for example, user 105a, selects an impression on a web page hosted by processing unit A 115, user 105a is directed to a respective web page hosted by processing unit B 140 of party B 155. Moreover, processing unit B 140 can also host one or more web pages that include one or more impressions, which can be viewed on communication devices 110a. . . 110n.

For instance, user 105a may select a banner on a web page displayed on communication device 110a and hosted by a financial service institution, party A 150. The banner advertises another company's product, e.g., party B's 155 product such as a computer. If user 105a selects the banner, user 105a is directed to a different web page hosted by the company selling the computer, e.g., party B 155. Upon interacting with that web page, user 105a may perform one or more predetermined tasks, for example, purchase the computer from party B 155.

On party A 150's web page, party B 155 may display a plurality of impressions. Each of the plurality of impressions has a unique identifier, but clicking on any one of the plurality of impressions may lead the user 105a to the same web page hosted by party B 155. The unique identifier identifies which impression was clicked. Accordingly, the selected banner may be one of a plurality of other impressions on the web page or on another web page of party A 150 that would direct user 105a to the same web page of party B 155 in order to purchase the computer.

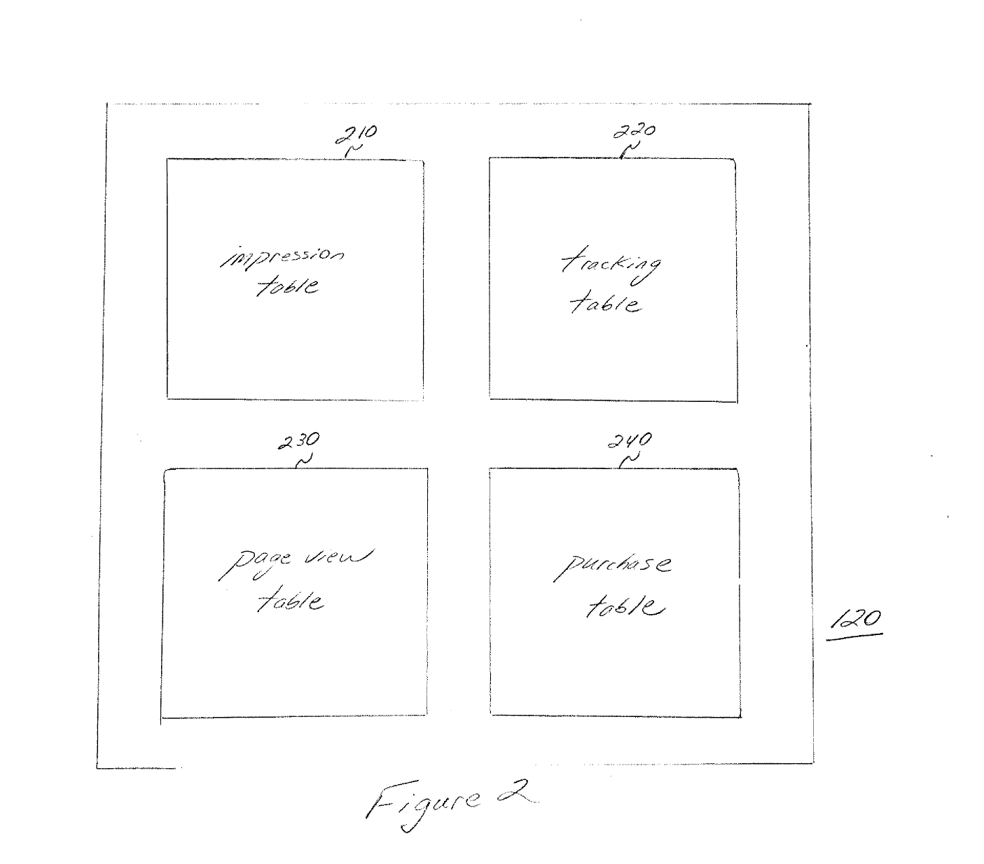

Memory unit 120 includes various types of data or database stored in it. As shown in FIG. 2, memory unit 120 stores, e.g., impression table 210, tracking table 220, page view table 230, and purchase table 240. In one embodiment, two or more of these tables 210, 220, 230, 240 are arranged as relational tables. Memory unit 120 may also store information about users 105a . . . 105n, such as name, address(es), telephone number(s), social security number, age, marital status, profession and/or ethnicity. The components of FIG. 1 may be implemented through hardware, software, and/or firmware. The number of components in tracking system 100 is not limited to what is illustrated.

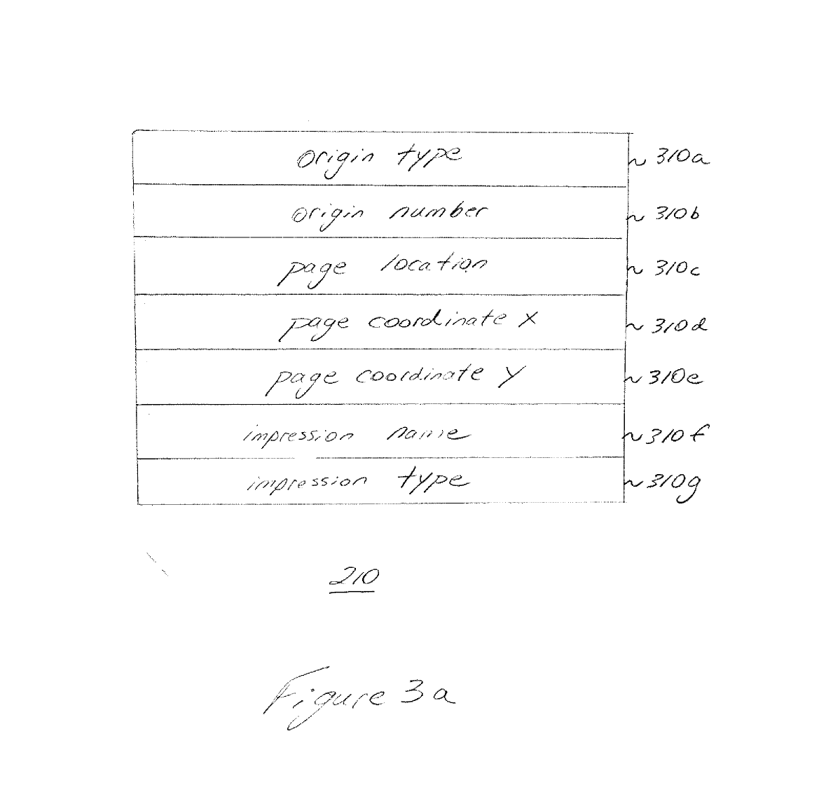

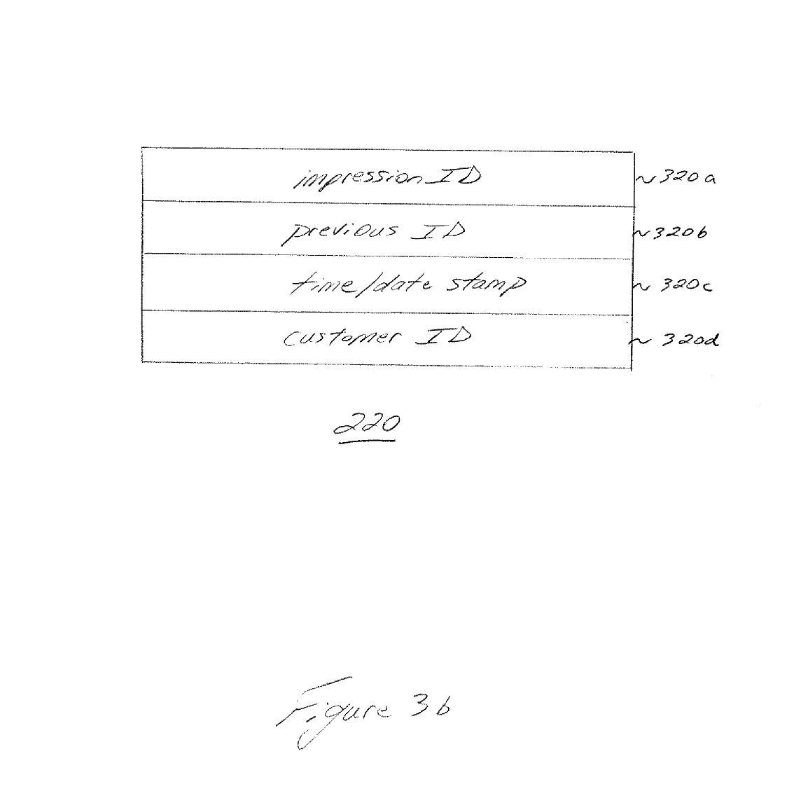

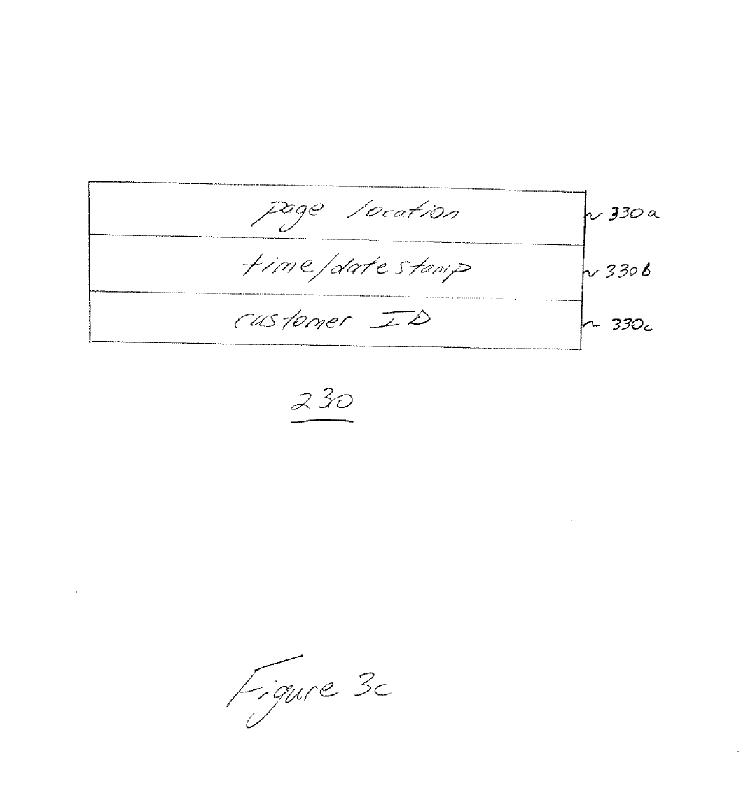

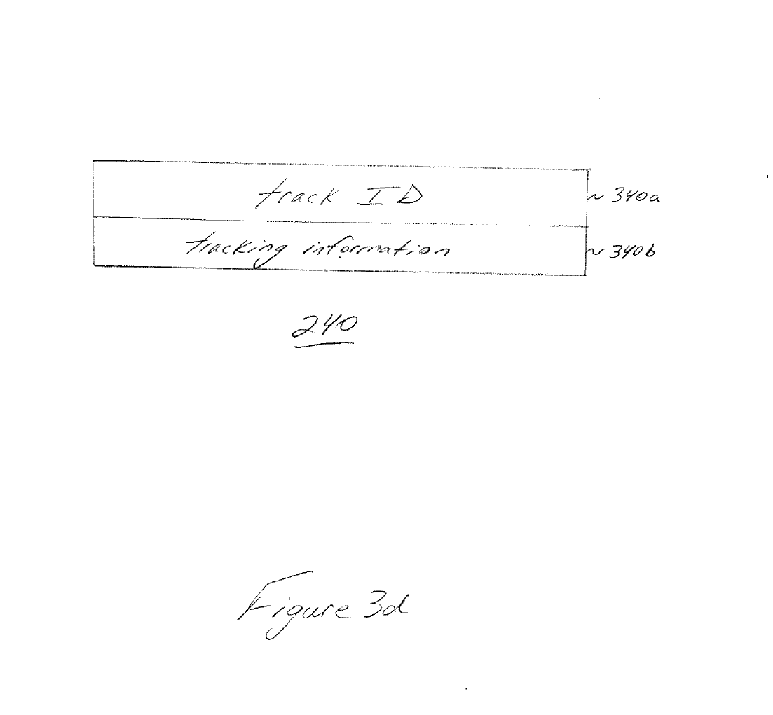

In one embodiment, each impression may be associated with e-mail or a web page. Each impression has impression table 210, tracking table 220, page view table 230 and purchase table 240 stored in memory unit 220. Impression table 210 for the respective impression includes one or more data entries or records. FIG. 3a illustrates an example of data fields in the impression table shown in FIG. 2. E.g., impression table 210 includes data entries such as origin type 310a, origin number 310b, page location 310c, page coordinate x 310d, page coordinate y 310e, banner name 310f and banner type 310g, as shown in FIG. 3a.

Origin type 310a may be the type of impression, e.g., whether the impression is located on a particular web page or in e-mail. Origin number 310b may be a unique number to differentiate the impressions having the same origin type 310a. Page location 310c may be an indication of the web page on which the impression is located, e.g., the URL from where the user clicked on the impression. Page coordinates x 310d and y 310e may be the x and y-coordinates of the impression on the respective web page. Impression name 310f may be an alias for the respective impression to differentiate the impression from other impressions on the same web page and impression type 310g may be an indication whether the impression is a banner, link, associated with an e-mail, or other. An example of an impression type is a name of a banner to identify it from other banners on the same web page.

FIG. 3b illustrates an example of data fields in the tracking table shown in FIG. 2. In one embodiment, a tracking table 220 stores data associated with a selected impression. Tracking table 220 for the respective impression includes one or more data entries or records. E.g., tracking table 220 includes data entries such as impression identifier (“ID”) 320a, previous ID 320b, time and date stamp 320c and customer ID 320d.

In one embodiment, impression ID 320a is a unique index associated with the impression that was selected by one of users (105a . . . 105n FIG. 1). In one embodiment, previous ID 320b is an index code associated with a previously clicked impression. Time and date stamp 320c may be the time and date that the user selected the impression. Customer ID 320d identifies the user (105 . . . 105n FIG. 1) that clicked on the impression.

In one embodiment, impression ID 320a is assigned to a particular impression by the ID assignment unit 125 (FIG. 1) of processing unit A 115 (FIG. 1). The ID assignment unit (125 FIG. 1) may automatically assign this ID. Alternatively, an operator may initiate the assigning the impression ID 320a.

FIG. 3c illustrates an example of data fields in the page view table shown in FIG. 2. Page view table 230 for the respective impression includes one or more data or record entries. E.g., page view table 230 may include data entries such as page location 330a, time and date stamp 330b and customer ID 330c. Page location 330a identifies the web page that includes the impression. This field may be indicated by the URL of the web page, and similar to the page location field (310c, FIG. 3a) in the impression table (210, FIG. 3a). Time and date stamp 330b is the time and date the web page that includes the selected impression was served to the user (105a . . . 105n FIG. 1). Customer ID indicates the user (105 . . . 105n FIG. 1) to whom the page was served.

FIG. 3d illustrates an example of data fields in the purchase table shown in FIG. 2. Purchase table 240 for the respective impression includes one or more data or record entries. E.g., purchase table 240 may include data entries such as track ID 340a and tracking information 340b. Track ID 340a may be the unique identification code, e.g., the impression ID (320a, FIG. 3b) of the last selected impression before the user (105a . . . 105n FIG. 1) was sent to a web site or web page of party B (155 FIG. 1). Tracking information 340b may be tracking information to be transmitted to party A (150 FIG. 1) and/or party B (155 FIG. 1). Tracking information may include an impression id, which is passed to a partner, e.g., from party A to party B. When the user fulfills a predetermined action at the party B's web page, party B transmits the impression id back to party A, identifying the user and the transaction fulfilled by the user while on the party B's web page.

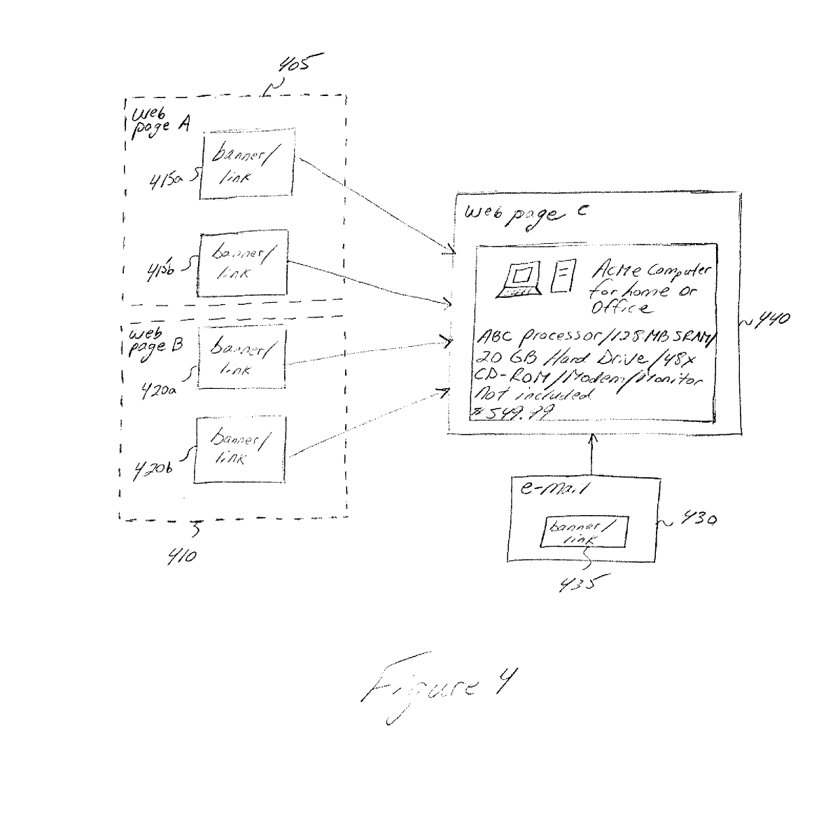

FIG. 4 illustrates examples of web pages viewable to users (105a . . . 105n FIG. 1) on displays of communication devices (110a . . . 110n FIG. 1), respectively. E.g., user (105a FIG. 1) operating communication device (110a FIG. 1) may navigate through web page A 405, web page B 410, and web page C 440. Web page A 405 includes selectable impressions such as banner/link 415a and banner/link 415b. Web page B 410 includes selectable impressions such as banner/link 420a and banner/link 420b.

In one embodiment, each of the impressions 415a, 415b, 420a, 420b directs user 105a to web page C 440 when the user (105a FIG. 1) selects one of the impressions 415a, 415b, 420a, 420b. Moreover, user (105a FIG. 1) may receive an e-mail 430, for example, on communication device (110a FIG. 1), containing an impression, such as banner/link 435, whereby user (105a FIG. 1) may select the impression to be directed to web page C 440.

Web page A 405 and web page B 410 may be hosted by processing unit A (115 FIG. 1) of party A (150 FIG. 1). In addition, party A (150 FIG. 1) may be responsible for sending e-mail 430 to one or more users (105a . . . 105n FIG. 1). Web page A 405, web page B 410, or e-mail 430 may also be hosted by other processing units and parties. Web page C 440 may be hosted by processing unit B 140 of party B 155. Alternatively, web page C 440 may be hosted by other processing units, e.g., by processing unit A (115 FIG. 1 ) or another processing unit associated with party A (150 FIG. 1).

As will be described below in further detail, fulfillment notification unit (145 FIG. 1) of processing unit B (155 FIG. 1) notifies processing unit A (115 FIG. 1) that a particular one of users (105a . . . 105n FIG. 1) has performed at least one predetermined task, such as purchasing an item. E.g., a user (105a FIG. 1) may purchase an ACME computer advertised on web page C 440,from party B (155 FIG. 1) after selecting banner/link 420b displayed on web page B 410. As a result, processing unit A (115 FIG. 1) is informed that a particular user, e.g., user (105a FIG. 1), purchased a particular item, e.g., the ACME computer, from party B (155 FIG. 1) after the user (105a FIG. 1) was led to party B (155 FIG. 1) by selecting a specific impression, banner/link 415a on a web page, e.g., web page A 405.

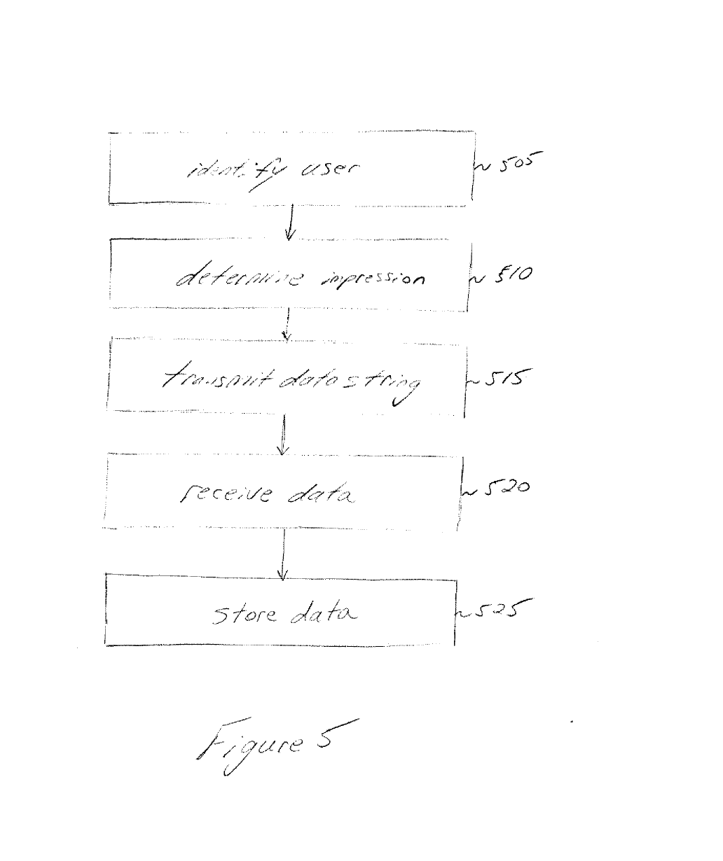

FIG. 5 illustrates an example of a flow diagram for tracking the impression selected by a user that leads to a subsequent task(s) performed by the user. At 505, processing unit A (115 FIG. 1) identifies a user (105a FIG. 1) accessing web page A (405 FIG. 4) or web page B (410 FIG. 4) via communication device (110a FIG. 1).

In one embodiment, user (105a FIG. 1) is identified by processing unit (115 FIG. 1) by requiring user (105a FIG. 1) to log into a web site, e.g., to enter a user name and password. This logging-in allows a user (105a FIG. 1) to access web page A (405 FIG. 4) and web page B (410 FIG. 4), a portion of web page A (405 FIG. 4) and web page B (410 FIG. 4), or one or more other web pages associated with web page A (405 FIG. 4) or web page B (410 FIG. 4).

Processing unit A (115 FIG. 1) accesses information stored in memory unit (120 FIG. 1), such as user names and passwords, to identify and verify user (105a FIG. 1). Processing unit A (115 FIG. 1) also accesses information stored in memory unit (120 FIG. 1) to retrieve additional information about user (105a FIG. 1). Examples of additional information include name, address(es), telephone number(s), social security number, age, marital status, profession, and ethnicity.

In a case where user clicks on an impression or advertisement link provided as part of an e-mail message, that user may be identified by, e.g., looking up user's information. This information may be in a form of a cookie, e.g., stored on the user's device from which the user is accessing the impression or advertisement link. Typically, when a user receives one or more impressions or advertisement links as part of an e-mail message, that user is already registered with the web site providing the impressions or advertisement links. Accordingly, user information may have been stored as, e.g., a cookie on the user's device. Alternatively, user may be asked to enter his or her name and any other information related to the user. The user information is then transmitted to the web site in a, e.g., URL to the web site providing the products or services advertised on the impressions or advertisement links.

After user (105a FIG. 1) is identified, the tracking unit (130 FIG. 1) of processing unit A (115 FIG. 1) monitors the activities of a user (105a FIG. 1) as the user (105a FIG. 1) views web page A (405 FIG. 4) or web page B (410 FIG. 4). While monitoring the activities of the user (105a FIG. 1), the tracking unit (130 FIG. 1) at 510 determines which impression on web page A (405 FIG. 4) or web page B (410 FIG. 4) the user (105a FIG. 1) selected which directed the user (105a FIG. 1) to web page C (440 FIG. 4). In one embodiment, the tracking unit (130 FIG. 1) determines the selected impression by at least referring to an impression ID included within the parameters of the URL or embedded scripting language for the respective impression.

Party A 150 may decide which impressions on web page A 405 and web page B 410 are tracked. In one embodiment, a scripting language such as Javascript is used by party A (150 FIG. 1) to track an impression. As those skilled in computer programming will understand, Javascript is a scripting language commonly used to create dynamic web pages. Briefly, Javascript allows programmers, e.g., to create interactive games on a web site, detect a web site visitor's browser type, store cookies on users' machines, validate form data and code impressions.

E.g., party A (150 FIG. 1) tracks banner/link 415a, banner/link 415b, banner/link 420a, and banner/link 420b using Javascript. An example of such tracking for an impression (415a FIG. 4) on web page A (405 FIG. 4) may include the following:

<ahref=“javascript: impress (‘RUP’, ‘pb005, ‘pbban005’, ‘banner’, ‘369’, ‘257’, ‘page.php’);”>link</a>, where

RUP represents origin type,

Pb005 represents origin number,

Pbban005 represents banner name,

Banner represents banner type,

369 represents x-coordinate on the display,

257 represents y-coordinate on the display, and

page.php represents which page to go to.

When a user (105a FIG. 1) selects impression (415a FIG. 4), its impression ID (320a FIG. 3b) is appended to the URL of the destination site, e.g., the URL of web page C (440 FIG. 4). At 515, the URL with the appended impression ID is transmitted to processing unit B (140 FIG. 1) of party B (155 FIG. 1). An example of the destination URL with the appended impression ID may be:

http://www.xxxxxx.com/ctg/cgi-bin/xxxxxx.xxxxx?ref=pgcap_FCR ba02&ImpressID=X,

where X is an impression ID.

In one embodiment, Javascript passes parameters, e.g., those described above but not limited to such, using Web Distributed Data Exchange (“WDDX”) packets. WDDX allows for adding new parameters without having to modify other software or programs. Briefly, as known to those having ordinary skill in computer programming, WDDX is an XML-based technology that enables the exchange of complex data between web programming languages. WDDX consists of a language-independent representation of data.

Using WDDX to transfer data, party B (155 FIG. 1) may capture data associated with user's (105a FIG. 1) web navigations and activities. Party B (155 FIG. 1) may send the captured data back to party A (150 FIG. 1) also using WDDX. The data would indicate user's activities such as buying an item.

After selecting banner/link (415a FIG. 4) on web page A (405 FIG. 4), user (105a FIG. 1) may navigate through web page C (440 FIG. 4) and associated web pages on communication device (110a FIG. 1). User (105a FIG. 1) may perform at least one predetermined task in association with web page C (440 FIG. 4), e.g., purchase an item.

In one embodiment, user (105a FIG. 1) views at least one web page, referred to as success web page, after completing the purchase process. A success web page is a web page that users (105a . . . 105n FIG. 1) may view only if the users (105a . . . 105n FIG. 1) have successfully completed a revenue-generating activity, for example, made a purchase. These success web pages may also be used to keep track of number of successful sessions that led to a predetermined task.

At 520, Party A (150 FIG. 1) receives the data associated with the user's purchase from processing unit B (140 FIG. 1) of party B (155 FIG. 1). The data may include track ID, impression ID, purchased product information, etc. An example of a URL that may include the data may be:

http://www.xxxxx.com/php/https-misc/impression/FirstImpression
Partner.php?Packet=<WDDX_Packet>,

where <WDDX_Packet> may be the following string: <wddxPacket version=‘1.0’><header><comment>PHP</comment>

</header><data><struct><varname=‘TRACKID’><number>ImpressID</numb er></var><varname=‘PRODUCTID_n’><string>ProductID</string></var></struct></data></wddxPacket>.

The packet is URL-encoded before the packet is sent to processing unit A (115 FIG. 1) by fulfillment notification unit (145 FIG. 1). A sample packet after purchasing a computer chair, a computer and a computer table from party B 155 may be:

http://www.xxxxx.com/php/https-

misc/impression/ImpressionPartner.php?Packet=<wddxPacket%20version=‘1.0’><header><comment>PHP</comment></header>data><struct><var %20name=‘TRACKID’><number>25<//number></var><var%20name=‘PRODUCTID_{—}1’><string>computerchair38</string></var><vart20name=‘PRODUCTID_{—}2’>string><computer23</string></var><var%20name=‘PRODUCTID_{—}3’><string>computertable13</string></var></struct></data></wddxPacket>.

At 525, the tracking unit (130 FIG. 1) of processing unit A (115 FIG. 1) stores the received data in memory unit 120. The data may be stored in the purchase table (240 FIG. 2). The stored data indicates that a particular impression was selected by a particular user and that the user purchased particular items from party B (155 FIG. 1). Accordingly, party A (150 FIG. 1) may retrieve data from memory unit (120 FIG. 1) and organize the retrieved data to determine, e.g., who purchased what from where. In particular, as a result of processing unit A 115 monitoring which of the users (105a . . . 105n FIG. 1) accessed web site A (405 FIG. 4) or web site B (410 FIG. 4), tracking unit (130 FIG. 1) may determine the characteristics of the particular user, which impression or series of impressions were selected by that user, and whether the selection led to a purchase by the user and, if so, what was the purchase.

Although a predetermined task that a user performs at the destination web site was described above as a purchase, the successful completion of one or more predetermined tasks by users (105a . . . 105n FIG. 1) may be defined according to the type of business associated with web page C (440 FIG. 4). E.g., success may be defined by leads, loans funded, click thru's, sales, or sign-ups.

In addition, during the tracking process additional data may be captured to allow companies to analyze on-line user behavior, and use the data accordingly to meet its business needs. The data may include but not limited to: the number of times a page was served; the day and time of the served page; the page views based on registered and non-registered users; and the page views based on specific account holders.

The system and method of the present invention may be implemented and run on a general purpose computer. The Internet and the World Wide Web have been used as an example of a communication medium in this application to describe the invention in one embodiment. The communication network, however, is not limited only to the Internet. The system and method of the present invention may be utilized in connection with LAN, WAN, wireless, and any other communication network that may be used for communicating.

The embodiments described above are illustrative examples of the present invention and it should not be construed that the present invention is limited to these particular embodiments. Various changes and modifications may be effected by one skilled in the art without departing from the spirit or scope of the invention as defined in the appended claims. Accordingly, the present invention is not limited except as by the appended claims.

We claim:

1. A method for tracking user activity, comprising:
identifying the user accessing a first web page;
determining that an impression associated with the first web page was selected by the user after the user has been identified, the impression having a unique identification associated with the impression and being one of a plurality of impressions for directing the user to a second web page;
transmitting at least the unique identification of the selected impression to a website associated with the second web page upon the user selecting the impression;
receiving from the website data indicating that the user successfully performed at least one predetermined task and the unique identification; and
storing the received data in a memory unit.

2. The method of claim 1, wherein a plurality of links are located on the first web page.

3. The method of claim 1, wherein the at least one predetermined task is a purchase.

4. The method of claim 1, wherein the at least one predetermined task is a sign-up.

5. The method of claim 1, wherein the at least one predetermined task is a click thru.

6. The method of claim 1, wherein the unique identification is a string of characters.

7. The method of claim 1, wherein identifying the user accessing a first web page includes requiring the user to input a user name.

8. The method of claim 1, wherein identifying the user accessing a first web page includes requiring the user to input a user name and password.

9. A method of tracking user activity, comprising:
transmitting data including an identifier to a web site associated with a web page in response to the user selecting an impression associated with an electronic mail, the impression having the unique identifier and for directing the user to the web page;
receiving from the web site data indicating that the user successfully performed at least one predetermined task and the identifier; and
storing the received data and data identifying the user in a memory unit.

10. A method for tracking user activity, comprising:
associating a user accessing a first user interface page with a user identifier, the user interface page having one or more advertisement links to one or more second user interface pages;
identifying an advertisement link selected by the user among the one or more advertisement links, the advertisement link for directing the user to a second user interface page;
associating the advertisement link with a link identifier;
transmitting the user identifier and the link identifier to a server serving the second user interface page;
receiving from the server the user identifier, the link identifier, and data associated with user's activity on the second user interface page, the data used to track on-line activity of the user.

11. The method of claim 10, further including:
storing the user identifier, the link identifier, and the data.

12. The method of claim 10, wherein the first user interface includes electronic mail.

13. The method of claim 10, wherein the first user interface includes a web page.

14. The method of claim 10, wherein the second user interface includes a web page.

15. The method of claim 10, wherein the advertisement link includes an impression.

16. The method of claim 10, wherein the link identifier includes an impression identifier.

17. A tracking system, comprising:
a first processing unit for identifying the user accessing a first web page having an impression,
an identification assignment unit for assigning a unique identification to the impression, the impression being one of a plurality of impressions for directing the user to a second web page; and
a tracking unit for determining that an impression associated with the first web page was selected by the user, the tracking unit transmitting at least the unique identification of the selected impression to a web site associated with the second web page in response to the user selecting the impression, the tracking unit further receiving data indicating that the user successfully performed at least one predetermined task and the unique identification.

18. The system of claim 17, further including
a memory unit for storing the received data in at least one database table.

19. The system of claim 17, further including:
a second processing unit for hosting the web site associated with the second web page;
a fulfillment notification unit for transmitting to the tracking unit the unique identification and the data indicating that the user successfully performed at least one predetermined task.

20. A program storage device readable by machine, tangibly embodying a program of instructions executable by the machine to perform method steps of tracking user activity, comprising:
associating a user accessing a first user interface page with a user identifier, the user interface page having one or more advertisement links to one or more second user interface pages;
identifying an advertisement link selected by the user among the one or more advertisement links, the advertisement link for directing the user to a second user interface page;
associating the advertisement link with a link identifier;
transmitting the user identifier and the link identifier to a server serving the second user interface page;
receiving from the server the user identifier, the link identifier, and data associated with user's activity on the second user interface page, the data used to track on-line activity of the user.

21. The program storage device of claim 20, wherein the one or more advertisement links include one or more impressions.
